(19) United States
(12) Patent Application Publication
(10) Pub. No.: US 2012/0233905 A1
(43) Pub. Date: Sep. 20, 2012

(54) SLEEVE

(76) Inventor: Catherine Holt, Draper, UT (US)

(21) Appl. No.: 13/421,030

(22) Filed: Mar. 15, 2012

Related U.S. Application Data
(60) Provisional application No. 61/465,402, filed on Mar. 18, 2011.

(51) Int. Cl. A01K 97/01

(52) U.S. Cl. 43/4

(57) ABSTRACT

A sleeve configured to be disposed substantially within an ice fishing hole, including a cylindrical body member having a top aperture, a bottom aperture, an interior surface, and a tapering exterior surface, such that an exterior diameter of a top portion of the exterior surface is larger than an exterior diameter of a bottom portion of the exterior surface. The exterior surface of the cylindrical body member includes a hydrophobic layer. The sleeve includes an L-shaped flange extending as a ring outwardly from a region between the top portion and bottom portion of the exterior surface of the cylindrical body member, thereby preventing the sleeve from falling through the ice fishing hole and thereby substantially covering the ice fishing hole. The sleeve includes a cover member sized and shaped to fit over the top aperture of the cylindrical body member.

### CROSS-REFERENCE TO RELATED APPLICATIONS

This invention claims priority, under 35 U.S.C. §120, to the U.S. Provisional Patent Application No. 61/465,402 to Catherine Holt filed on Mar. 18, 2011, which is incorporated by reference herein.

### BACKGROUND OF THE INVENTION

1. Field of the Invention

The present invention relates to ice fishing, specifically to a sleeve configured to be disposed over a ice fishing hole.

2. Description of the Related Art

Ice fishing is the practice of catching fish with lines and fish hooks or spears through an opening in the ice on a frozen body of water. Ice anglers may sit on a stool in the open on a frozen lake, or in a heated cabin on the ice, some with bunks and amenities. Ice fishing gear is highly specialized. An ice saw, auger or chisel is used to cut a circular or rectangular hole in the ice. The size of the hole generally is 6 inches, 8 inches, or 10 inches. A skimmer, a large metal spoon with holes in it, is used to remove new ice as it forms and to clear slush left from making the hole. During colder periods most ice anglers choose to carry a heater of some type. The heater is not only for warmth but it also for keeping an angler's fishing hole from freezing. When temperatures fall to −20° F. (−29° C.) or colder it becomes very hard to keep a fishing hole open.

Ice and snow around an ice fishing hold tend to become slick, especially where a heater is used. Personal items, like cell phones, keys, and the like, of fishermen often are accidentally knocked down the ice hole and are often irretrievable or damaged. Further, in some regions of the world, ice fishing is extremely popular and consistent losses of items contribute to pollution in the bodies of water where the fishing occurs.

Some improvements have been made in the field. Examples of references related to the present invention are described below in their own words, and the supporting teachings of each reference are incorporated by reference herein:

U.S. Pat. No. 6,568,120, issued to Smolinski, discloses an ice fishing trap is provided to be suspended within an ice fishing hole such that once a fish has been pulled partway through the hole the fish will remain caught even if the fish is freed from the fishing line having initially caught the fish thereon. A collar is suspended within the ice fishing hole by a pair of support arms arranged to rest on a top side of the sheet of ice in which the ice fishing hole is bored. A plurality of gate members are pivotally mounted about a periphery of the collar to extend radially inward therefrom. Each gate member is a wedge shaped member having a blunt end positioned adjacent the center of the opening of the collar in the closed position. The blunt ends of the gate members are arranged to grip a fish therebetween as they are pivoted upward into an open position to grip the fish even if the fish is only pulled partway therethrough.

U.S. Pat. No. 6,684,553, issued to Holum, discloses a fish retaining assembly for ice fishing for containing and retaining a fish being reeled in by an angler. The fish retaining assembly for ice fishing includes an elongate tubular member having open top and bottom ends and a passageway extending therethrough and being adapted to be disposed through a hole in ice and being partially disposed in water; and also includes a support assembly including a belt being fastenable about the elongate tubular member, and also including support members being spacedly and hingedly attached to the belt for resting upon the ice and supporting the elongate tubular member in the hole in the ice; and further includes a trap door assembly including a trap door member being pivotally attached to a bottom of the elongate tubular member and being closable over the open bottom end, and also including a trap door moving member being attached to the trap door member for the opening and closing of the trap door member.

U.S. Pat. No. 5,956,882, issued to Deimel, discloses a device used to maintain a hole formed in the ice for ice fishing. When placed over the hole, this invention forms a therm-protection between the hole and the surrounding harsh environment protecting the open water in the hole from crystallizing and ultimately freezing over. This device utilizes the natural temperature differences between the unfrozen water and the surrounding air and combines it with emitted radiation (naturally, electrically, chemically, or with petroleum-based products). Examples of this emitted radiation are the sun, a battery-powered heater, light source and a propane or similar type heater. An example of a chemical reaction device would be a hand warmer. Addition of any or all of the above will increase the efficiency of this invention. This device allows for adaptability to fishing conditions and fishing devices ranging from a simple rod and reel to complicated fish locators as well as a variety of tip-ups.

U.S. Pat. No. 5,844,210, issued to Dowdle, discloses an electrical heating device to prevent freezing of water within an ice fishing hole which includes a sleeve, an electrical resistance heater and a pair of electrical leads. The sleeve substantially forms a circle with an inner and an outer surface. The outer surface contacts the ice at the periphery of the ice fishing hole with sufficient outward pressure to suspend the heating device within the ice fishing hole. The electrical resistance heater is mounted to the inner surface of the sleeve and includes an electrical resistance heating element (or elements) enclosed within a waterproof jacket. The waterproof jacket forms a substantially circular base which is connected around the inner surface of the sleeve. The pair of electrical leads extend from the electrical resistance heater and connect the electrical resistance heater to a battery.

U.S. Pat. No. 5,911,569, issued to Isakson, discloses an ice fishing hole cover and indicator generally includes a base having a pole engagement end which is adapted to hold a conventional ice fishing rod and reel. A cover end is positioned opposite to the pole engagement end which includes a catch. A trip latch is provided which is adapted for adjustable and releasable engagement to the catch. The trip latch is rotatably engaged to the cover indicator which, in turn, is pivotally engaged to the cover end of the base. A fishing line is engaged to the trip latch to release the indicator cover from the cover end for vertical positioning relative thereto upon the taking of the bait by a fish. The base and cover end are adapted to be placed over an ice fishing hole, preventing the freezing thereof during ice fishing activities. The indicator cover, upon release from the cover end, functions to advise a fisherman as to the existence of a fish on the fisherman's line.

The inventions heretofore known suffer from a number of disadvantages which include being limited in use, being difficult to install, being bulky, being burdensome to use, being difficult to maintain, being expensive, being inflexible, being unstable, being difficult to carry, being difficult to remove from ice, being unstackable, being difficult to remove from a hole, causing line snags, being able to be used only in one mode, being difficult to use in deep snow, being difficult to remove ice therefrom, causing the loss of personal items down an ice hole, not preventing the loss of personal items down an ice hole, failing to properly rest inside an ice hole, failing to sufficiently extend above and/or below an ice hole, being subject to damage by freezing, and causing line cuts and the like and combinations thereof.

What is needed is a sleeve that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available ice fishing hole sleeves. Accordingly, the present invention has been developed to provide an effective ice fishing hole sleeve.

According to one embodiment of the invention, there is a sleeve configured to be disposed substantially within an ice fishing hole. The sleeve may include a cylindrical body member that may be sized and shaped to be slightly smaller in diameter than a diameter of an ice fishing hole. The cylindrical body member may be configured to be disposed therein. The cylindrical body member may be acircular.

The cylindrical body member may include a top aperture. The top aperture may include a rounded top edge. The top edge of the top aperture of the cylindrical housing may be substantially saddle shaped. The cylindrical body member may include a bottom aperture, disposed opposite of the top aperture. The bottom aperture may include a bottom edge of that may be rounded. The cylindrical body member may include an interior surface. The cylindrical body member may include a tapering exterior surface, such that an exterior diameter of a top portion of the exterior surface may be larger than an exterior diameter of a bottom portion of the exterior surface. The bottom portion of the exterior surface may be smooth. The exterior surface of the cylindrical body member may include a hydrophobic layer disposed thereon. The exterior surface and interior surface of the cylindrical body may include an outer region of hydrophobic plastic. The cylindrical body member may include a weakened region that may be configured to flex substantially more than a remainder of the cylindrical body. The weakened region may include a wall portion of lesser thickness than its surrounding wall thickness.

The sleeve may include an L-shaped flange that may be extending as a ring outwardly from a region between the top portion of the exterior surface of the cylindrical body member and the bottom portion of the exterior surface. The L-shaped flange may be configured to rest on a top surface of an ice layer surrounding an ice fishing hole, thereby preventing the sleeve from falling through the ice fishing hole and thereby substantially covering the ice fishing hole. The L-shaped flange may also include a protrusion that may be extending outwardly and downwardly from the cylindrical body member. The L-shaped flange may include a pair of recessed portions that may be configured to operate as handles to facilitate manipulating the sleeve.

The sleeve may include a cover member that may be sized and shaped to fit over the top aperture of the cylindrical body member. The cover member may include an aperture that may be disposed through a top portion thereof. The aperture may be configured to enable a user to fish therethrough. The sleeve may include a pair of handle members that may be configured to extend through the exterior surface of the cylindrical body member into the interior surface of the cylindrical body member.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 illustrates an ice fisherman fishing through a sleeve, according to one embodiment of the invention;

FIG. 2 is an exploded view of a sleeve and a cover member, according to one embodiment of the invention;

FIG. 3 is a partial side cross-sectional view of a sleeve, according to one embodiment of the invention;

FIG. 4 is a side elevational view of a sleeve having a saddle-shaped top portion, according to one embodiment of the invention;

FIG. 5 is a top plan view of a sleeve, according to one embodiment of the invention;

FIG. 6 is a bottom plan view of a sleeve, according to one embodiment of the invention; and

FIG. 7 is a side perspective view of a plurality of sleeves invertedly stacked together, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

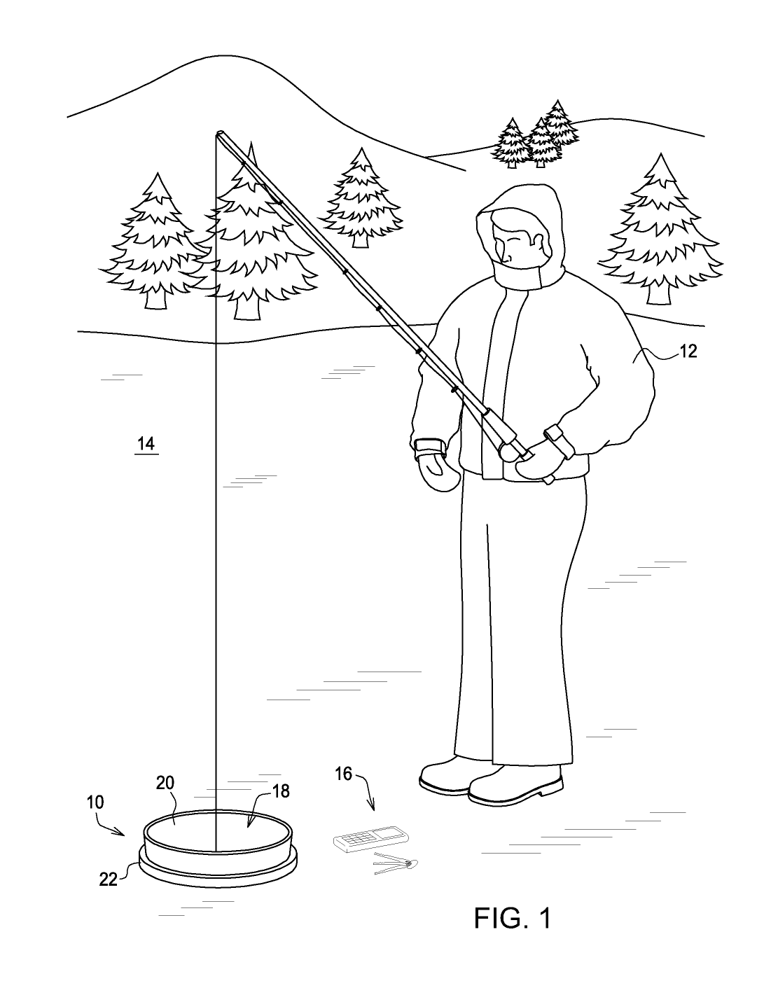

FIG. 1 illustrates an ice fisherman fishing through a sleeve, according to one embodiment of the invention. There is shown an ice fisherman 12 fishing through a sleeve 10 on a frozen surface 14.

The illustrated sleeve 10 is configured to be disposed within an ice fishing hole 18 through a frozen surface 14, such as a frozen lake, pond, reservoir, etc. The sleeve 10 is configured to prevent personal items or objects 16, such as cell phones, keys, jewelry, clothing, etc. or other items, such as fishing equipment, fish, bait, fishing rods and reels, etc. to slip into the ice fishing hole 18 while fishing or doing fishing related functions. The sleeve 10 is configured to provide a raised barrier to prevent items from falling into the ice fishing hole 18. The sleeve 10 includes a cylindrical body member 20 sized and shaped to be slightly smaller in diameter than a diameter of the ice fishing hole 18. The sleeve 10 includes an L-shaped flange 22 configured to rest above the frozen surface 14 and cover the ice fishing hole 18, thereby preventing items of objects from falling therethrough.

In one non-limiting embodiment, there is an ice fishing device adapted to enable a fisherman to minimize the loss of personal items, equipment and caught fish down an ice hole. There may be a plastic cylindrical casing (sleeve) that tapers from the top to the bottom which sits in the ice hole with an outward support. The sleeve may be characterized as a hole guard. The sleeve can be lifted out of the hole even when there is ice disposed within the sleeve and any ice clinging or stuck within the sleeve will be brought out, so it can be dumped out by inverting the sleeve and/or “cracking” the sleeve much like one would do with an ice tray, namely by twisting the sleeve from side to side, especially where the sleeve includes “weakened” regions configured to facilitate twisting of the structure to “crack” the ice.

In the non-limiting embodiment of this example, the sleeve has hydrophobic characteristics, by being composed of and/or including layers of hydrophobic materials such as but not limited to Teflon, hydrophobic Lexan by GE of Fairfield Conn., Diamon Fusion brand coatings by Diamon Fusion International of Irvine Calif. and/or hydrophobic surface treatments such as but not limited to that provided by TriStar Plastics Corp. and the like and combinations thereof, so it more easily separates from ice. The hole guard will support a tip-up off the ice.

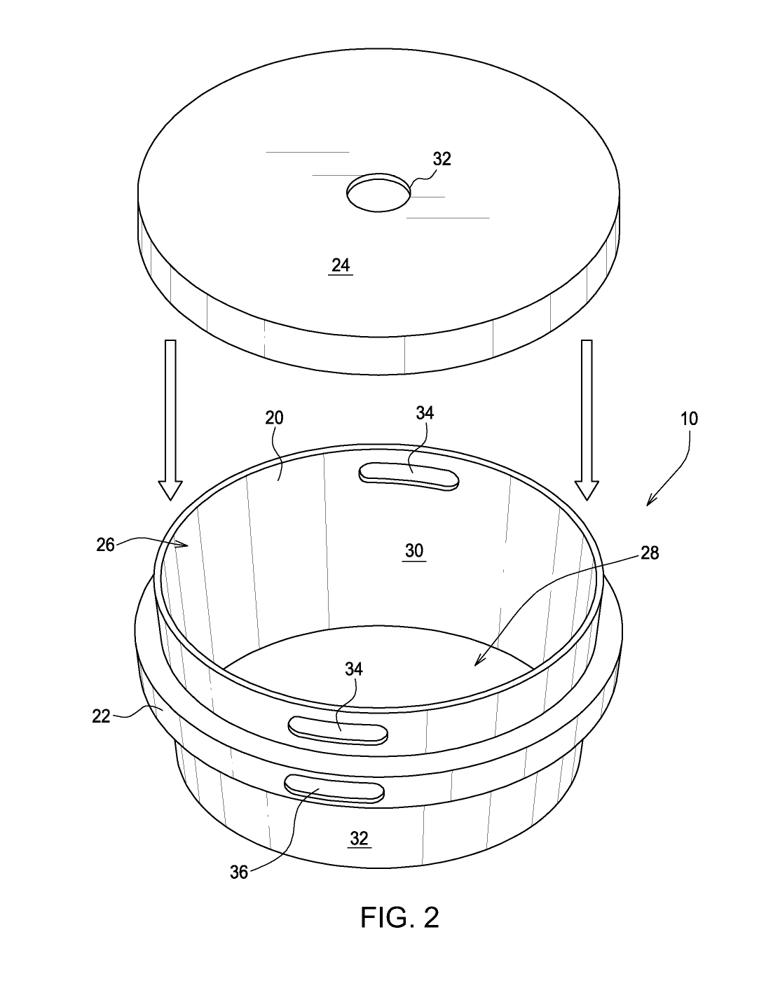

In the non-limiting embodiment of this example, the outward support is an L-shaped ring that points downward into the ice. This L-shaped structure provides a wide ring of coverage around the sleeve that advantageously permits the sleeve to protect a hole that is substantially larger than the actual body of the sleeve so that random materials (phones, keys, etc.) are protected from dropping down the hole, while the downward facing tip of the L-shaped structure minimizes the actual contact surface area of that protective structure with the ice, thereby limiting adhesion of the L-shaped ring to the ice surface and making it easier to remove therefrom. The L-shaped ring advantageously also prevents the sleeve from falling into the hole and makes it easier to stack. The sleeve of the present example is made of a flexible plastic and includes structure that facilitates flexing (changing the overall shape of the sleeve body in response to applied force) so that ice can be dislodged from the sides by twisting the hole guard, much like how one breaks ice from an ice cube tray. The structure may be one or more of a variety of structures configured to facilitate flexing, including but not limited to an acircular shaped L-shaped (ellipse, rectangle, etc.) with the ring being sized to cover the hole that extends beyond the acircular part, asymmetry in the thickness of the sleeve body at different parts around the sleeve; asymmetry in the type of plastic (or other material) used I the constructions of the sleeve body such that portions of the sleeve body are more flexible than other portions and therefore flexing tends to be exaggerated and/or focused along such regions, and the like and combinations thereof. FIG. 2 illustrates an exploded view of a sleeve and a cover member, according to one embodiment of the invention. There is shown a sleeve 10 including a cover member 24.

The illustrated sleeve 10 is configured to be disposed substantially within an ice fishing hole. The sleeve 10 includes a cylindrical body member 20 sized and shaped to be slightly smaller in diameter than a diameter of an ice fishing hole. The cylindrical body member is acircular. The typical size of an ice fishing hole is either six inches, eight inches, or ten inches in diameter, therefore, the cylindrical body member 20 is sized and shaped to be slightly smaller in diameter than six inches, eight inches, and ten inches to correspond to the matching size and shape of an ice fishing hole.

The cylindrical body member 20 includes a top aperture 26 and a bottom aperture 28. The cylindrical body member 20 is configured to enable an ice fisherman to continue fishing while also preventing items or objects from falling or slipping into an ice fishing hole and down to the bottom of a body of ice water. The cylindrical body member 20 also includes an interior surface 30 and a tapering exterior surface 32. The tapering exterior surface 32 is configured to enable an ice fisherman to easily remove the sleeve 10 from the ice fishing hole, wherein a non-tapering exterior surface is more likely to be stuck to an interior ice wall of the ice fishing hole.

The sleeve 10 includes an L-shaped flange 22 extending as a ring outwardly from a region between the top aperture 26 of the cylindrical body member and the bottom aperture 28. The L-shaped flange 22 is configured to rest on a top surface of an ice layer surrounding an ice fishing hole, thereby preventing the sleeve 10, along with other items and objects, from falling through the ice fishing hole and thereby substantially covering the ice fishing hole.

The sleeve 10 includes a cover member 24 sized and shaped to fit over the top aperture 26 of the cylindrical body member 20. The cover member 24 includes an aperture 32 disposed through a top portion thereof. The aperture 32 is configured to enable a fisherman to fish therethrough while having the cover member 24 disposed on the sleeve 10. The sleeve 10 includes a pair of handle members 34 configured to extend through the exterior surface 32 of the cylindrical body member 20 into the interior surface 30 of the cylindrical body member 20. The illustrated sleeve 10 also includes a pair of handle members 36 disposed on the L-shaped flange 22. The pair of handle members 36 are configured to enable a user/fisherman to remove the sleeve 10 from an ice fishing hole. In one non-limiting embodiment, handle members 36 through the L-shaped ring may be embodied as a cut-away portion of the L-shaped ring instead of a cut-out, meaning that the portion of the illustrated handle 36 that is illustrated that would trap the hand and be in contact with the ice in the illustrated handle, may be missing entirely, such that no portion of the handle is ever in contact with the ice during normal use.

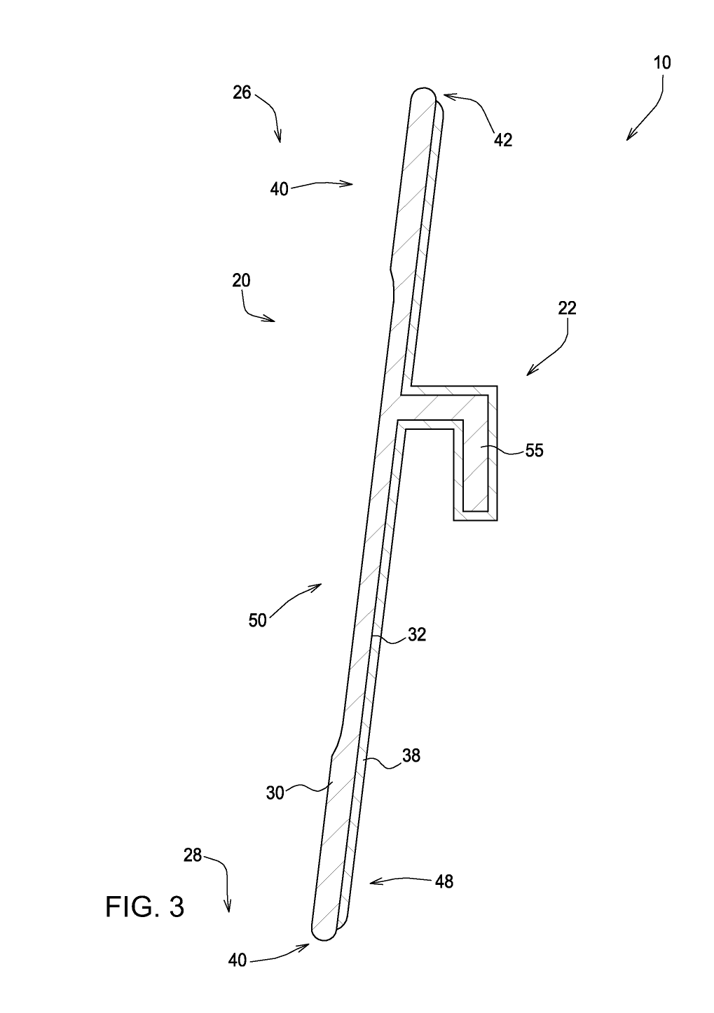

FIG. 3 illustrates a partial side cross-sectional view of a sleeve, according to one embodiment of the invention. There is shown a sleeve 10 including an interior surface 30 and an exterior surface 32.

The illustrated sleeve 10 includes a cylindrical body member 20 sized and shaped to be slightly smaller in diameter than a diameter of an ice fishing hole. The cylindrical body member 20 includes a top aperture 26. The top aperture 26 includes a top edge having a rounded top edge 42. The cylindrical body member 20 includes a bottom aperture 28, disposed opposite of the top aperture 26. The bottom aperture 28 includes a bottom edge having a rounded bottom edge 40.

The cylindrical body member 20 includes an interior surface 30. The cylindrical body member 20 also includes a tapering exterior surface 32. The exterior surface 32 of the cylindrical body member 20 includes a hydrophobic layer 38 disposed thereon.

The sleeve 10 includes an L-shaped flange 22 extending as a ring outwardly from a region between a top portion 40 of the exterior surface 32 and a bottom portion 48 of the exterior surface 32 of the cylindrical body member 20. The L-shaped flange 22 is configured to rest on a top surface of an ice layer surrounding an ice fishing hole, thereby preventing the sleeve 10 from falling through the ice fishing hole. The L-shaped flange 22 also includes a protrusion 55 extending outwardly and downwardly from the cylindrical body member 20. The protrusion 55 is in an inverted L-shaped configuration.

The cylindrical body member 20 includes a weakened region 50 that is configured to flex substantially more than a remainder of the cylindrical body 20. The weakened region 50 includes a wall portion of lesser thickness than its surrounding wall thickness. Such a region may be a spot, line, spiral, or otherwise shaped to facilitate flexing of the sleeve body.

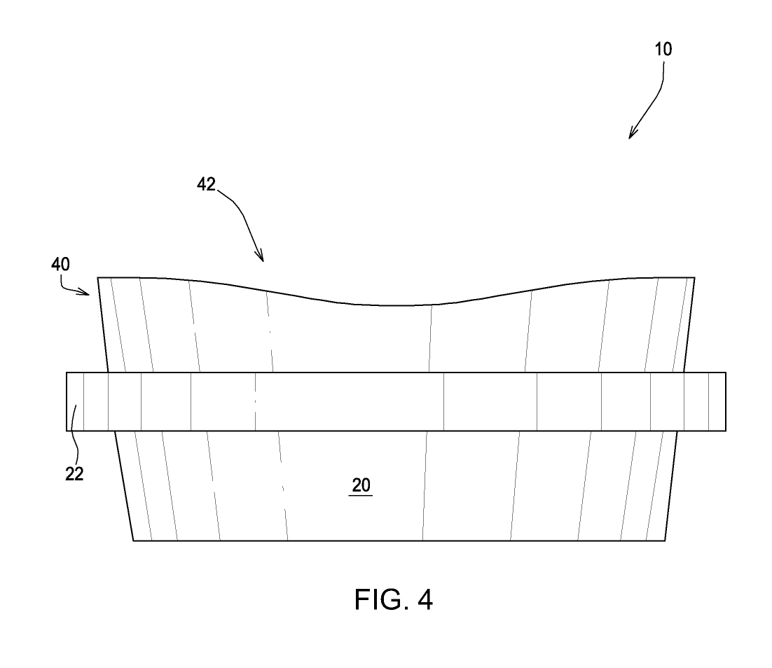

FIG. 4 illustrates a side elevational view of a sleeve, according to one embodiment of the invention. There is shown a sleeve 10 including a cylindrical body member 20.

The illustrated sleeve 10 includes a cylindrical body member 20 configured to be disposed within an ice fishing hole. The cylindrical body member 20 includes an L-shaped flange 22 extending as a ring outwardly from the cylindrical body member 20. The L-shaped flange 22 is configured to rest on a top surface of an ice layer surrounding an ice fishing hole, thereby preventing the sleeve 10 from falling through the ice fishing hole and thereby substantially covering the ice fishing hole. The L-shaped flange 22 may be configured to be the only contact point between the sleeve and the top surface of the ice layer surrounding the ice fishing hole. The illustrated cylindrical body member 20 includes a top portion 40 having a top edge, wherein the top edge of a top aperture of the cylindrical body member 20 is substantially saddle-shaped 42.

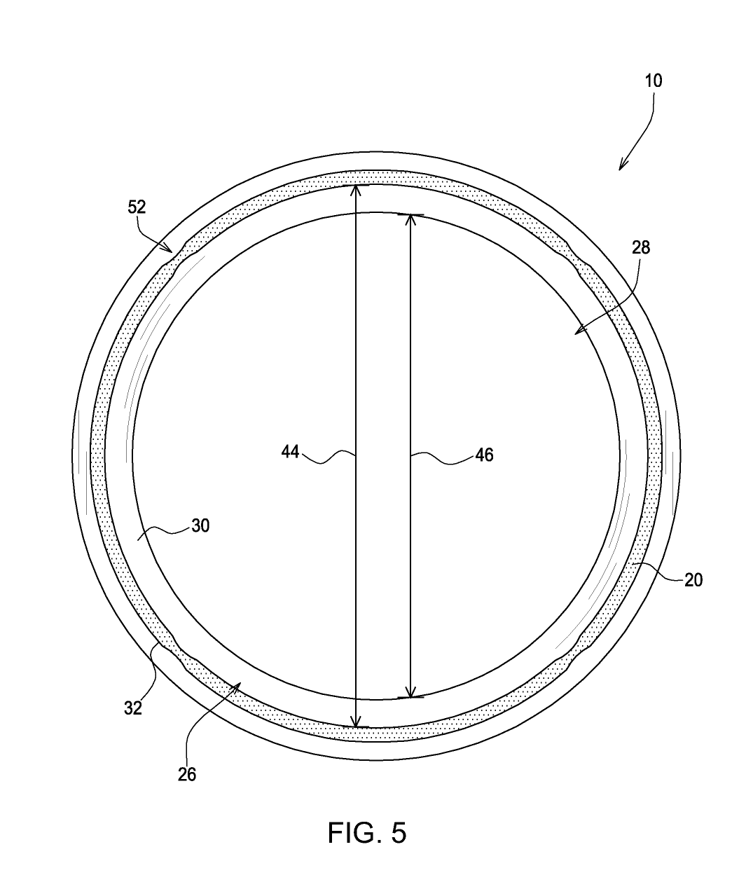

FIG. 5 illustrates a top plan view of a sleeve, according to one embodiment of the invention. There is shown a sleeve 10 including a cylindrical body member 20 having a top aperture 26 and a bottom aperture 28.

The illustrated sleeve 10 includes a cylindrical body member 20 sized and shaped to be slightly smaller in diameter than a diameter of an ice fishing hole. The cylindrical body member 20 includes a top aperture 26 and a bottom aperture 28, disposed opposite of the top aperture 26. The cylindrical body member 20 includes an interior surface 30 and a tapering exterior surface 32, such that an interior diameter of a top portion 44 of the exterior surface 32 is larger than an interior diameter of a bottom portion 46 of the exterior surface 32.

The cylindrical body member 20 includes a weakened region 52 that is configured to flex substantially more than a remainder of the cylindrical body 20. The weakened region 52 includes a wall portion of lesser thickness than its surrounding wall thickness. Such may be embodied as lines that may partially or fully extend along a length of the sleeve body both above and below the L-shaped ring or just on one side or the other or just in a region near the L-shaped ring but not extending to either end. There may be one or more weakened regions, such as but not limited to 1, 2, 3, 4, 5, 6, 7, 8, 9, 10 or a multitude of regions. Such regions may be positioned at angles around a perimeter of the sleeve relative to each other, including but not limited to the following angles 10, 20, 25, 30, 33, 45, 60, 65, 66, 90, 120, 180, and the like and combinations thereof.

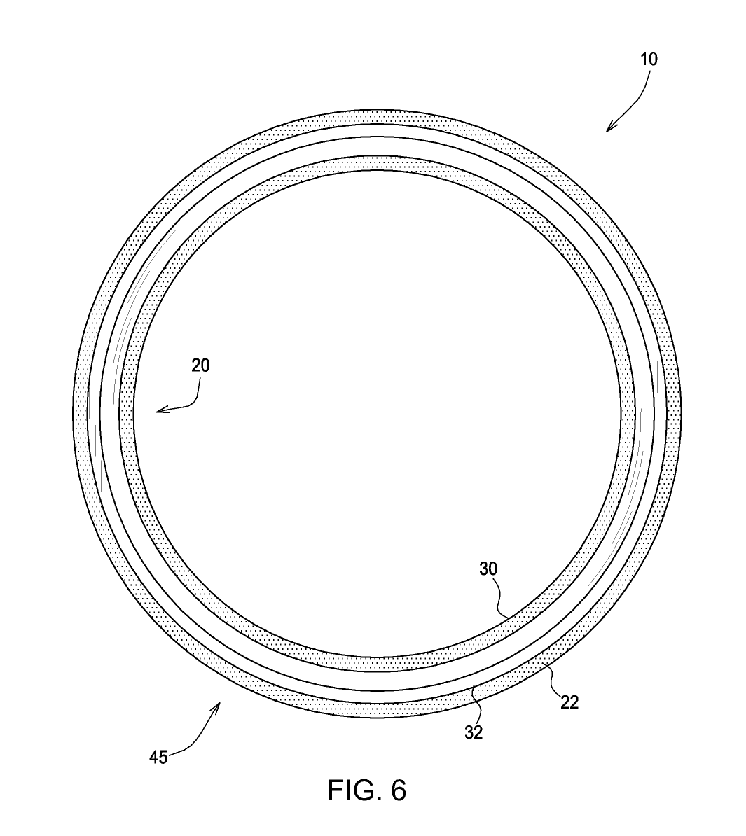

FIG. 6 illustrates a bottom plan view of a sleeve, according to one embodiment of the invention. There is shown a sleeve 10 including a cylindrical body member 20.

The illustrated sleeve 10 includes a cylindrical body member 20 having an interior surface 30 and an exterior surface 32. The cylindrical body member 20 also includes an L-shaped flange 22 extending as a ring 45 outwardly from a region between a top portion of the exterior surface 32 and a bottom portion of the exterior surface 32. The L-shaped flange is configured to rest on a top surface of an ice layer surrounding an ice fishing hole, thereby preventing the sleeve 10 from falling through the ice fishing hole and thereby substantially covering the ice fishing hole. The L-shaped flange may include a hydrophobic layer, material, treatment, or the like along the bottom tip region that comes in contact with the ice, thereby reducing adhesion thereto. The L-shaped flange may include a hydrophilic layer, material, treatment, spot, portion, or the like disposed along a bottom tip region that comes in contact with the ice, thereby enhancing adhesion thereto. As a non-limiting example, there may be one or more spots of hydrophilic materials, including but not limited to porous plastics, hydrophilic PMMA (poly methyl methacrylate) and related acrylate monomers containing one or more hydroxyl groups, cotton fibers, and the like and combinations thereof. Such a structure may provide points/regions/strips/etc. of adhesion while making it easy to break such adhesion by surrounding those regions with regions of hydrophobic material in contact with the ice. Accordingly, under small stress (such as that associated with a small object striking the sleeve), the sleeve remains securely in place and under larger or more systematic stress, the sleeve dislodges as desired.

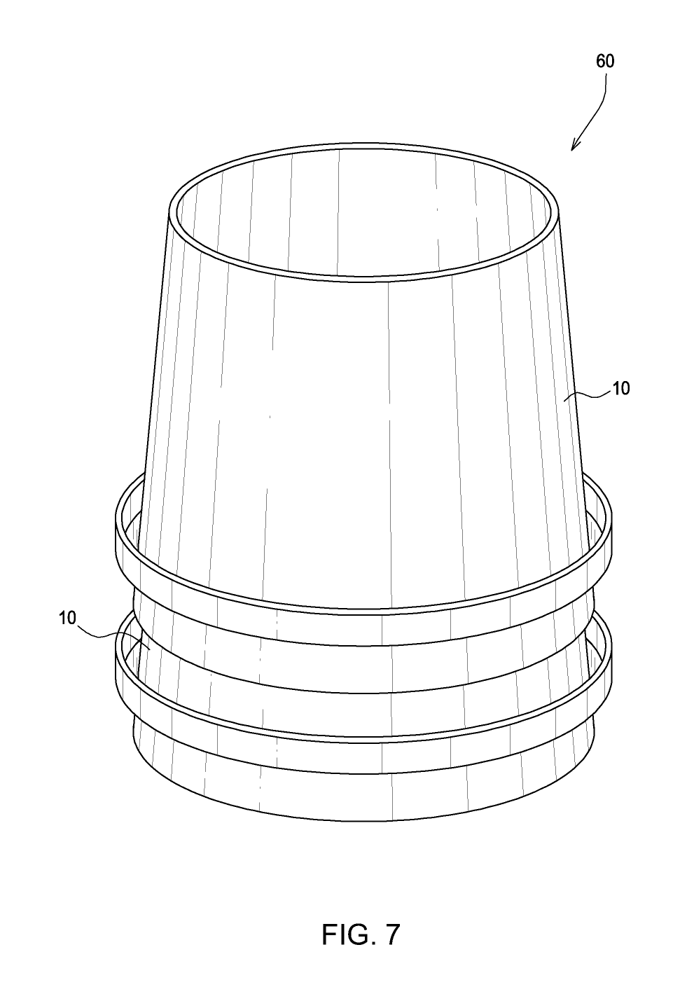

FIG. 7 illustrates a plurality of sleeves in a stacked configuration, according to one embodiment of the invention. There is shown a pair of sleeves 10 disposed one on top of another in a stacked configuration 60.

The illustrated pair of sleeves 10 are in an inverted position and in a stacked configuration 60. The inverted position includes a top portion of a cylindrical body member of a first sleeve disposed into a bottom portion of a cylindrical body member of a second sleeve. The top portion of the first sleeve is configures to rest adjacent a top portion of the second sleeve. The sleeves 10 are configured to be disposed one on top of another to minimize space during storage.

Further, advantageously, a plurality of sleeves may be so configured and coupled such that the composite sleeve may be used in regions where there is deeps snow and a larger and perhaps even selectably variable height is desired for the composite sleeve. Where additional height is desired, one need to merely add another sleeve to the stack.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although the L-shaped ring is illustrated as not having a tapering profile (See FIG. 3), it is understood that the L-shaped ring may taper either outwardly or inwardly if so desired and that it may have rounded/pointed tips or tips otherwise shaped than the exact shapes illustrated.

Additionally, although the figures illustrate particular embodiments of the invention, it is understood that the various features, structures, and etc. described and illustrated herein may be included/excluded in plethoric ways.

It is expected that there could be numerous variations of the design of this invention. An example is that the illustrated circular profile, as seen from the top/bottom views may be acircular, elliptical, ovoid, rectangular, square, triangular, irregularly shaped, and the like while the L-shaped ring may continue to be circular or may be shaped in any manner listed above.

Finally, it is envisioned that the components of the device may be constructed of a variety of materials, including but not limited to plastics, resins, glass, metals, woven fibers, ceramics, wood, natural materials, composites, and the like and combinations thereof.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A sleeve configured to be disposed substantially within an ice fishing hole, comprising:
a) a cylindrical body member sized and shaped to be slightly smaller in diameter than a diameter of an ice fishing hole and configured to be disposed therein; including:
a1) a top aperture;
a2) a bottom aperture, opposite the top aperture;
a3) an interior surface; and
a4) a tapering exterior surface, such that an exterior diameter of a top portion of the exterior surface is larger than an exterior diameter of a bottom portion of the exterior surface; and
b) an L-shaped flange extending as a ring outwardly from a region between the top portion of the exterior surface of the cylindrical body member and the bottom portion of the exterior surface and configured to rest on a top surface of an ice layer surrounding an ice fishing hole, thereby preventing the sleeve from falling through the ice fishing hole and thereby substantially covering the ice fishing hole.

2. The sleeve of claim 1, further comprising a cover member sized and shaped to fit over the top aperture of the cylindrical body member.

3. The sleeve of claim 1, wherein the bottom portion of the exterior surface is smooth.

4. The sleeve of claim 1, wherein the top aperture includes a rounded top edge.

5. The sleeve of claim 1, wherein the top edge of the top aperture of the cylindrical housing is substantially saddle shaped.

6. The sleeve of claim 1, wherein the L-shaped flange further comprises a protrusion extending outwardly and downwardly from the cylindrical body member.

7. The sleeve of claim 2, wherein the cover member further comprises an aperture disposed through a top portion thereof, and configured to enable a user to fish therethrough.

8. The sleeve of claim 1, further comprising a pair of handle members configured to extend through the exterior surface into the interior surface of the cylindrical body member.

9. The sleeve of claim 1, wherein the exterior surface of the cylindrical body member includes a hydrophobic layer disposed thereon.

10. The sleeve of claim 1, wherein the cylindrical body member is acircular.

11. The sleeve of claim 1, wherein the cylindrical body member further comprises a weakened region configured to flex substantially more than a remainder of the cylindrical body.

12. The sleeve of claim 1, wherein the weakened region includes a wall portion of lesser thickness than its surrounding wall thickness.

13. The sleeve of claim 1, wherein the L-shaped flange further comprises a pair of recessed portions configured to operate as handles to facilitate manipulating the sleeve.

14. The sleeve of claim 1, wherein the exterior and interior surface of the cylindrical body include an outer region of hydrophobic plastic.

15. The sleeve of claim 1, wherein a bottom edge of the bottom aperture is rounded.

16. A sleeve configured to be disposed substantially within an ice fishing hole, comprising:
a) a cylindrical body member sized and shaped to be slightly smaller in diameter than a diameter of an ice fishing hole and configured to be disposed therein; including:
a1) a top aperture;
a2) a bottom aperture, opposite the top aperture;
a3) an interior surface;
a4) a tapering exterior surface, such that an exterior diameter of a top portion of the exterior surface is larger than an exterior diameter of a bottom portion of the exterior surface; and
a5) a weakened region configured to flex substantially more than a remainder of the cylindrical body; and wherein the weakened region includes a wall portion of lesser thickness than its surrounding wall thickness; and
b) an L-shaped flange extending as a ring outwardly from a region between the top portion of the exterior surface of the cylindrical body member and the bottom portion of the exterior surface and configured to rest on a top surface of an ice layer surrounding an ice fishing hole, thereby preventing the sleeve from falling through the ice fishing hole and thereby substantially covering the ice fishing hole; wherein the L-shaped flange further comprises a protrusion extending outwardly and downwardly from the cylindrical body member; wherein the L-shaped flange further comprises a pair of recessed portions configured to operate as handles to facilitate manipulating the sleeve.

17. The sleeve of claim 16, wherein the sleeve further comprising:
a) a cover member sized and shaped to fit over the top aperture of the cylindrical body member; wherein the cover member further comprises an aperture disposed through a top portion thereof, and configured to enable a user to fish therethrough; and
b) a pair of handle members configured to extend through the exterior surface into the interior surface of the cylindrical body member.

18. The sleeve of claim 17, wherein the bottom portion of the exterior surface is smooth;
wherein the top aperture includes a rounded top edge; wherein the top edge of the top aperture of the cylindrical housing is substantially saddle shaped; wherein a bottom edge of the bottom aperture is rounded.

19. The sleeve of claim 18, wherein the exterior surface of the cylindrical body member includes a hydrophobic layer disposed thereon; wherein the cylindrical body member is acircular; wherein the exterior and interior surface of the cylindrical body include an outer region of hydrophobic plastic.

20. A sleeve configured to be disposed substantially within an ice fishing hole, comprising:
a) a cylindrical body member sized and shaped to be slightly smaller in diameter than a diameter of an ice fishing hole and configured to be disposed therein; wherein the cylindrical body member is acircular; including:
a1) a top aperture; wherein the top aperture includes a rounded top edge;
wherein the top edge of the top aperture of the cylindrical housing is substantially saddle shaped;
a2) a bottom aperture, opposite the top aperture; wherein a bottom edge of the bottom aperture is rounded;
a3) an interior surface;
a4) a tapering exterior surface, such that an exterior diameter of a top portion of the exterior surface is larger than an exterior diameter of a bottom portion of the exterior surface; wherein the bottom portion of the exterior surface is smooth; wherein the exterior surface of the cylindrical body member includes a hydrophobic layer disposed thereon; wherein the exterior and interior surface of the cylindrical body include an outer region of hydrophobic plastic; and
a5) a weakened region configured to flex substantially more than a remainder of the cylindrical body; and wherein the weakened region includes a wall portion of lesser thickness than its surrounding wall thickness;
b) an L-shaped flange extending as a ring outwardly from a region between the top portion of the exterior surface of the cylindrical body member and the bottom portion of the exterior surface and configured to rest on a top surface of an ice layer surrounding an ice fishing hole, thereby preventing the sleeve from falling through the ice fishing hole and thereby substantially covering the ice fishing hole; wherein the L-shaped flange further comprises a protrusion extending outwardly and downwardly from the cylindrical body member; wherein the L-shaped flange further comprises a pair of recessed portions configured to operate as handles to facilitate manipulating the sleeve;
c) a cover member sized and shaped to fit over the top aperture of the cylindrical body member; wherein the cover member further comprises an aperture disposed through a top portion thereof, and configured to enable a user to fish therethrough; and
d) a pair of handle members configured to extend through the exterior surface into the interior surface of the cylindrical body member.
